(19) United States
(12) Patent Application Publication
(10) Pub. No.: US 2009/0196988 A1
(43) Pub. Date: Aug. 6, 2009

(54) HOLOGRAPHIC DISK WITH 2P TRACK-BEARING LAYER

(75) Inventors: Daniel J. Winarski, Tucson, AZ (US); Allen K. Bates, Tucson, AZ (US); Craig A. Klein, Tucson, AZ (US); Nils Haustein, Soergenloch (DE)

Correspondence Address: CARPENTER & ASSOCIATES, 5 PIPESTEM COURT, ROCKVILLE, MD, 20854, US

(73) Assignee: INTERNATIONAL BUSINESS MACHINES CORPORATION, Armonk, NY (US)

(21) Appl. No.: 12/023,398

(22) Filed: Jan. 31, 2008

(51) Int. Cl. B05D 5/06

(52) U.S. Cl. 427/165

(57) ABSTRACT

A method for forming a holographic storage media, including: applying a liquid photopolymer to a substrate of glass, quartz, or polycarbonate, the substrate having a first surface; engaging a stamper with a negative of desired tracks on the liquid photopolymer; curing the liquid photopolymer with ultraviolet light creating a plurality of tracks; applying a reflective layer to the plurality of tracks; applying a gap layer to the plurality of tracks; applying a dichronic mirror layer to the gap layer; and applying a holographic storage layer to the dichronic mirror layer.

### CROSS-REFERENCE TO RELATED APPLICATIONS

(Not Applicable)

### STATEMENT REGARDING FEDERALLY SPONSORED RESEARCH OR DEVELOPMENT

(Not Applicable)

### THE NAMES OF THE PARTY TO A JOINT RESEARCH AGREEMENT

(Not Applicable)

### INCORPORATION-BY-REFERENCE OF MATERIAL SUBMITTED ON A COMPACT DISC

(Not Applicable)

### BACKGROUND OF THE INVENTION

(1) Field of the Invention

This disclosure is directed to a holographic disk with a photopolymer track-bearing layer.

(2) Description of Related Art Including Information Submitted Under 37 CFR 1.97 and 1.98

Holographic disks can suffer from exposure to temperature and humidity that can cause image-distortion of the holograms stored on the holographic disk and eventually prevent the reading of those stored holograms.

The abstract of Kiyono (US 20060145373 A1) discloses that to “provide a process for producing a laminated optical recording medium with improved production efficiency, with which in production of an optical recording medium by a 2P process, a resin forming an interlayer and a light transmitting stamper can easily be separated without applying any constrained load. A process for producing a laminated optical recording medium, which comprises applying a precursor of an ultraviolet-curing resin on a recording layer containing an organic dye formed on a polycarbonate substrate, disposing a polypropylene light transmitting stamper comprising a nonpolar member having a concavo-convex shape thereon, curing the ultraviolet-curing resin and then easily separating the light transmitting stamper without applying any constrained load so that the concavo-convex shape is transcribed on the resin layer.”

The Patent Abstracts of Japan abstract of Ohira (JP 01-211342) discloses that to “improve the fitting accuracy of a center hub to a disk substrate by firmly forming a photopolymer layer to which a track pattern is transferred on the disk substrate and at the same time, by fixing the center hub to the disk base plate by adhesion.” The Ohira abstract further discloses that a “fluid photopolymer . . . is applied to the upper surface 1a of a disk 1 on which a track pattern . . . is formed . . . ” and that “they are pressed using a stamper . . . and the track pattern . . . on the disk . . . is transferred to the photopolymer . . . [and after] transferring the track pattern . . . , the photopolymer . . . is hardened by exposing the photopolymer . . . to ultraviolet rays . . . ”

Lehureau (U.S. Pat. No. 7,149,173) discloses “a method for making the above type of medium is planned, characterized in that, on a transparent substrate, said method involves the following steps: a) placing a layer of photopolymerizable monomer material on the substrate; b) applying to said layer a stamper, bearing the data to be recorded in the corresponding bearer plane, to spread said material; c) photopolymerizing said material using an appropriate light source; d) repeating steps a), b) and c) on each polymerized layer to obtain new data bearer planes.” According to Lehureau, it “can thus clearly be seen that the realization of a medium according to [the Lehureau] invention simply involves adapting the already known 2P technology.” See Lehureau lines 38-44 on column 2.

Hegel (U.S. Patent Publication No. 20020145772) discloses an environmentally protected holographic device construction.

### BRIEF SUMMARY OF THE INVENTION

At least some aspects of this disclosure are directed to a method for for forming a holographic storage media. Other aspects of this disclosure are directed to a holographic storage media that can be formed utilizing the methodologies disclosed herein. Other aspects of this disclosure are directed to methods for storing information on holographic storage media formed utilizing the methodologies disclosed herein. Other aspects of this disclosure are directed to information stored on holographic storage media formed utilizing the methodologies disclosed herein.

In particular, at least some aspects of this disclosure are directed to a method for forming a holographic storage media, including: applying a liquid photopolymer to a substrate of glass, quartz, or polycarbonate, the substrate having a first surface; engaging a stamper with a negative of desired tracks on the liquid photopolymer; curing the liquid photopolymer with ultraviolet light creating a plurality of tracks; applying a reflective layer to the plurality of tracks; applying a gap layer to the plurality of tracks; applying a dichronic mirror layer to the gap layer; and applying a holographic storage layer to the dichronic mirror layer.

At least some aspects of this disclosure are directed to a holographic storage media formed by applying a liquid photopolymer to a substrate of glass, quartz, or polycarbonate, the substrate having a first surface; engaging a stamper on the liquid photopolymer; curing the liquid photopolymer with ultraviolet light creating a plurality of tracks; applying a reflective layer to the plurality of tracks; applying a gap layer to the plurality of tracks; applying a dichronic mirror layer to the gap layer; and applying a holographic storage layer to the dichronic mirror layer. Some aspects of this disclosure are directed to a holographic storage media, further including that the reflective layer applied to the tracks is selected from the group of aluminum, gold, silver, and silicon. Some aspects of this disclosure are directed to a holographic storage media, further including that the photopolymer is an acrylate.

At least some aspects of this disclosure are directed to a photopolymer layer that forms tracks in a holographic disk. Some aspects of this disclosure are directed to the substrate of a holographic disk that is either glass that can mitigate hygroscopic effects or quartz that can mitigate both hygroscopic and thermal effects, and thus reduce image distortion over time.

Other exemplary embodiments and advantages of this disclosure can be ascertained by reviewing the present disclosure and the accompanying drawings.

### BRIEF DESCRIPTION OF THE SEVERAL VIEWS OF THE DRAWING(S)

This disclosure is further described in the detailed description that follows, with reference to the drawings, in which:

FIG. 1 shows a cross-section of a holographic disk with a 2P layer in accordance with at least some aspects of this disclosure; and

FIG. 2 shows a cross-section of an ultraviolet (UV) cure of a 2P layer with a stamper (mold) in place in accordance with at least some aspects of this disclosure.

### DETAILED DESCRIPTION OF THE INVENTION

Exemplary embodiments of this disclosure are described herein by way of example.

As discussed above, holographic disks can suffer from exposure to temperature and humidity that can cause image-distortion of the holograms stored on the holographic disk and eventually prevent the reading of those stored holograms. Aspects of this disclosure are directed to a substrate not affected by hygroscopic (water or humidity) effects. Further, this substrate may not be affected by thermal effects. By eliminating hygroscopic and thermal effects in the substrate, image-distortion can be mitigated.

Our disclosure advocates the use of a transparent glass or quartz substrate. However, common polycarbonate could be used as a substrate. A 2P layer is spread in liquid form and then UV cured while in contact with a stamper, to form tracks adjacent to the substrate to be used in the tracking-error-servo of the holographic drive, for reflective holographic media.

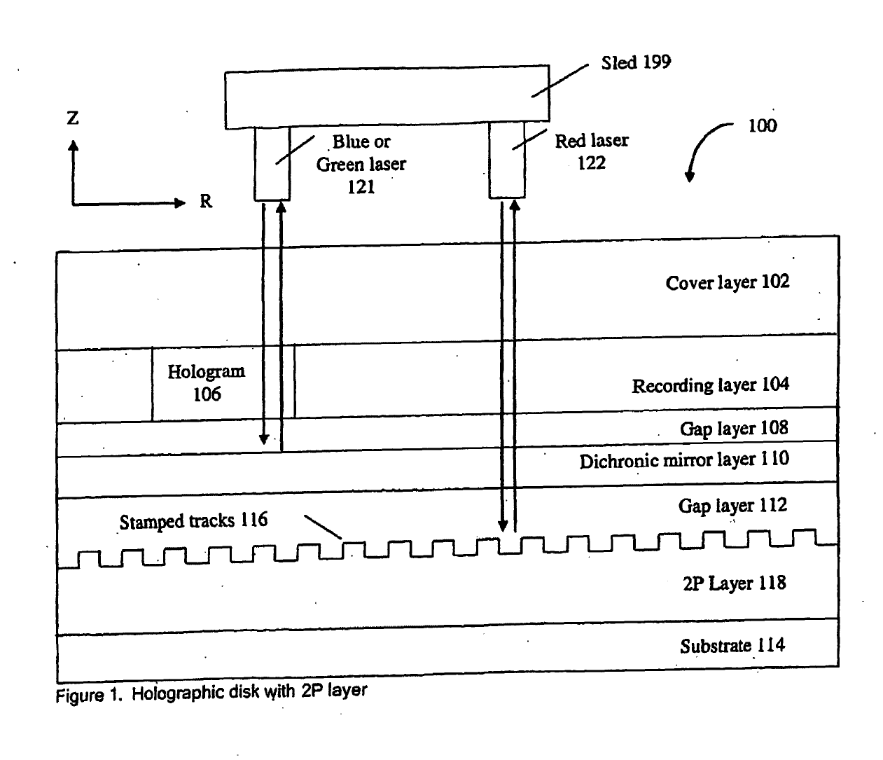

FIG. 1 shows a cross-sectional representation of single-layer reflective holographic media or disk 100 comprising transparent cover layer 102, holographic recording layer 104, gap layer 108, dichronic mirror layer 110, gap layer 112, tracks 116 formed in 2P layer 118, and substrate 114. Tracks 116 provide lands and grooves, but alternately 116 could alternately comprise a sequence of pits. Tracks 116 comprise either a plurality of concentric rings or a single, continuous spiral. Hologram 106 is written and read by light from a first laser 121, which makes first laser 121 a data laser. Light from first laser 121 may be either blue (405 nm) or green (514 or 532 nm) in wavelength, and it is selectively reflected by dichronic mirror layer 110, and thus does not penetrate to tracks 116 of holographic media 100. Holographic recording layer 104 is the principal, high-capacity, long-term data storage layer. Tracks 116 are used by the tracking-error-servo of the holographic disk drive to assist light from first laser 121 to read and write holograms to holographic recording layer 104.

Dichronic mirror layer 110 is selectively transparent to the wavelength of light from second laser 122, in this case red laser light of a wavelength of 680 nm, which is the same wavelength of the common DVD (Digital Versatile Disk). Second laser 122 and first laser 121 do not have the same wavelength. However, second laser 122 and first laser 121 are on the same physical sled 199 for radial seeks along disk 100. Tracks 116 may be coated with a layer such as gold, aluminum, silver, or silicon to make it more reflective and detectable by the light from second laser 122.

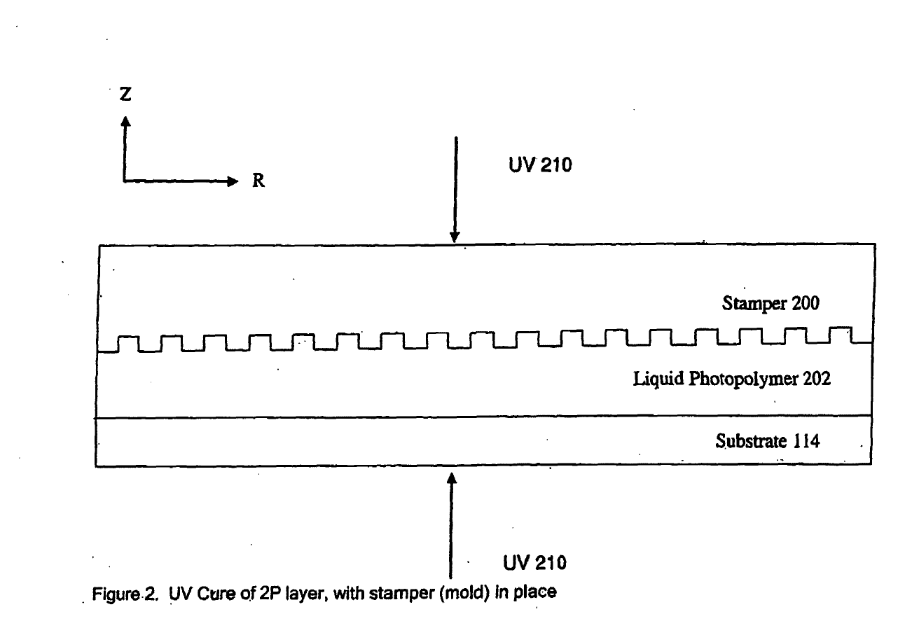

2P layer 118 is formed by the photopolymer process now defined, per FIG. 2. A liquid photopolymer coating 202, typically acrylate-based, is applied to substrate 114. A stamper 200 with the negative of the tracks 116 or pits desired is placed on this liquid photopolymer 202, with the plane of the stamper parallel to the plane of substrate 114. Then the liquid photopolymer coating 202 is cured via ultraviolet light 210, which causes the acrylate to cross-link and solidify. UV light 210 may come up through transparent substrate 114, or down through transparent stamper 200, or from both directions simultaneously. This UV cure forms 2P layer 118 (FIG. 1) which has a very low birefringence and which replicates extremely well the tracks or pits contained in the stamper 200. A bake step may be added after the UV exposure, before the rest of the layers shown in FIG. 1 are added to disk 100.

The foregoing exemplary embodiments have been provided for the purpose of explanation and are in no way to be construed as limiting this disclosure. This disclosure is not limited to the particulars disclosed herein, but extends to all embodiments within the scope of the appended claims, and any equivalents thereof.

1. A method for forming a holographic storage media, comprising:
applying a liquid acrylate photopolymer to a transparent substrate of glass, quartz, or polycarbonate, the substrate having a first surface;
engaging a transparent stamper with a negative of desired tracks on the liquid photopolymer;
curing the liquid photopolymer, first with ultraviolet light simultaneously up through the transparent substrate and down through the transparent stamper, and thereafter by baking, creating a plurality of tracks;
applying a reflective layer to the plurality of tracks;
applying a gap layer to the plurality of tracks;
applying a dichronic mirror layer to the gap layer; and
applying a holographic storage layer to the dichronic mirror layer.
